(19) United States
(12) Patent Application Publication
(10) Pub. No.: US 2021/0396599 A1
(43) Pub. Date: Dec. 23, 2021

(54) HEATING DEVICE COMPRISING A TEMPERATURE MEASURING DEVICE AND METHODS FOR TEMPERATURE MEASUREMENT AT THE HEATING DEVICE AND FOR PRODUCTION

(71) Applicant: E.G.O. Elektro-Geraetebau GmbH, Oberderdingen (DE)

(72) Inventors: Hannes Kuemmerle, Oberderdingen (DE); Kay Schmidt, Oberderdingen (DE); Manuel Schmieder, Oberderdingen (DE); Michael Tafferner, Malsch (DE); Henry Zipplies, Eppingen (DE)

(21) Appl. No.: 17/304,398

(22) Filed: Jun. 21, 2021

(30) Foreign Application Priority Data
Jun. 23, 2020 (DE) 10 2020 207 784.3

(51) Int. Cl. G01K 7/16; H05B 1/02

(52) U.S. Cl. CPC G01K 7/16; H05B 2203/021; H05B 1/0297; H05B 1/0294

(57) ABSTRACT

A heating device comprising a temperature measuring device has a sheet-like carrier, at least one heating conductor on said sheet-like carrier, an elongate electrode on the sheet-like carrier and a layer structure on the carrier with an insulation layer between the heating conductor and the electrode. A measuring apparatus for detecting local high temperatures at the heating device is connected to the electrode and to the heating conductor. Said measuring apparatus detects a temperature-dependent leakage current through the insulation layer between the heating conductor and the electrode and evaluates this as a measure of a local change in temperature at the heating device. The electrode consists of a material with a temperature dependence of its electrical resistance of between 0.0005/° C. and 0.01/° C. in a temperature range of between 0° C. and 200° C. A temperature measuring device is connected to the electrode for the purpose of measuring a temperature at the electrode using the temperature dependence of the electrical resistance of the electrode.

### CROSS-REFERENCE TO RELATED APPLICATIONS

This application claims priority to German Application No. 10 2020 207 784.3, filed Jun. 23, 2020, the contents of which are hereby incorporated herein in its entirety by reference.

### FIELD OF APPLICATION AND PRIOR ART

The invention relates to a heating device comprising a temperature measuring device for this heating device and to a method for temperature measurement at such a heating device and also to methods for producing such a heating device.

It is known from EP 3145273 B1 to provide a heating device with a temperature measuring device. The heating device has a sheet-like carrier, heating conductors and an electrically conductive connection area in the form of an electrode, where a dielectric layer is provided between the two. Here, a temperature-dependent leakage current through this dielectric layer can be detected by means of a measuring apparatus and evaluated as a measure of a local change in temperature at the heating device. However, experience has shown that local changes in temperature of this kind occur only close to or directly at the heating conductor. Furthermore, they substantially measure the temperature influenced by the heating conductor.

The invention is based on the object of providing a heating device and a method for temperature measurement using said heating device and methods for producing said heating device of the kinds mentioned at the outset and with which problems of the prior art can be solved and it is possible, in particular, to be able to advantageously produce or construct such a heating device and advantageously to be able to detect a temperature at said heating device.

This object is achieved by a heating device having the features of claim 1, by a method for temperature measurement at such a heating device having the features of claim 19 and by methods for producing such a heating device having the features of claim 21 or 23. Advantageous and preferred refinements of the invention are the subject matter of the further claims and will be explained in more detail below. In so doing, some of the features will be explained only for the heating device itself or only for one of said methods. However, irrespective of this, they are intended to be able to apply both to the heating device and to one of the methods autonomously and independently of one another. The wording of the claims is incorporated in the content of the description by express reference.

Provision is made for the heating device to have a sheet-like carrier and at least one heating conductor on the sheet-like carrier, where the heating conductor can optionally have a plurality of partial heating conductors or can be divided into a plurality of such partial heating conductors. Furthermore, an elongate electrode is provided on the sheet-like carrier, where either only one single elongate electrode can be provided or at least one further additional electrode can further be provided here too. A layer structure is provided on the carrier with an insulation layer between the heating conductor and the electrode. This insulation layer advantageously has dielectric properties, as is known per se from the prior art. Furthermore, a measuring apparatus for detecting local high temperatures at the heating device is provided, which measuring apparatus is connected to the electrode and to the heating conductor. The measuring apparatus is designed to detect a temperature-dependent leakage current through the insulation layer between the heating conductor and the electrode, which leakage current can lie in the region of a few mA. This temperature-dependent leakage current is evaluated as a measure of a local temperature or change in temperature at the heating device. This mechanism is known, in principle, from the prior art, to which reference is made in this respect, and therefore unnecessary repetition can be dispensed with here. In this way, it is primarily also possible to identify particularly high temperatures and, by way of taking countermeasures, to prevent said particularly high temperatures damaging the heating device or an electrical appliance comprising the heating device.

According to the invention, provision is made for the electrode itself to consist of a material with a temperature dependence of its electrical resistance, so that said electrode itself can be directly used for temperature measurement. Said electrode thus not only conducts a current serving as a signal but rather, as it were, itself detects the temperature as a kind of sensor. For this purpose, the temperature dependence of the electrical resistance of the electrode material lies between 0.0005/° C. and 0.01/° C. or between 0.000500=500 ppm/K and 10,000 ppm/K, in particular with respect to room temperature as reference, in a temperature range of 0° C. to 500° C. Furthermore, the temperature measuring device is connected to the electrode or to ends or connections of the electrode in order to measure a temperature at the electrode using the temperature dependence of the electrical resistance of the electrode. Such temperature measurement on the basis of a temperature-dependent electrical resistance is likewise sufficiently known to a person skilled in the art and can be implemented in accordance with this prior art. The special feature of the invention here is simply that the electrode that is used for said temperature detection on the basis of the leakage current is now also itself used as a temperature sensor on account of its specially provided temperature-dependent properties.

In a refinement of the invention, the temperature dependence of the electrical resistance of the electrode or of the electrode material can lie between 0.0015/° C. and 0.005/° C. or between 0.0015=1,500 ppm/K and 5,000 ppm/K, particularly advantageously at approximately 0.0035/° C. or 0.0035=3,500 ppm/K, in said temperature range of 0° C. to 200° C. The temperature-dependent resistance of the electrode can therefore be determined and the temperature can be precisely determined from the respective electrical resistance or the change in said electrical resistance.

Noble metal, for example silver, palladium, platinum, gold or ruthenium, can advantageously be used for the electrode. Independently of this, an electrode material with a PTC/NTC effect can also be used very generally.

In a refinement of the invention, it is possible for the electrode to be at least partially covered or overlapped by the heating conductor, in particular with respect to a projection onto the plane of the carrier. This carrier is very generally advantageously of flat or planar design, but it can also be of curved or tubular design, in particular the structure of the functional layers can be provided on the outer side of the tube. The insulation layer runs between the heating conductor and the electrode, where the insulation layer advantageously has a larger surface area or a much larger surface area than the region that is covered by the heating conductor and/or the electrode. Provision may also be made for a section of the electrode to run along a longitudinal extent of the heating conductor and in so doing equally to be covered or overlapped by the heating conductor. In particular, the electrode or a section of the electrode can run along at least 70% or 90% of the longitudinal extent of the heating conductor, so that temperature monitoring of the heating conductor is possible in this region. An electrode or a section of the electrode advantageously runs along the entire longitudinal extent of the heating conductor, so that the temperature can be monitored along the entire heating conductor. Maximum security against damage to the heating device due to an excessive temperature of the heating conductor can then be achieved.

In a refinement of the invention, the electrode can have a small width in comparison to its length. For example, the length can be at least twenty times the size of the width, preferably at least fifty times the size of the width. Therefore, relatively little electrode material, which is often expensive, is required for the electrode. In addition, such a relatively small width of the electrode is sufficient for the task of detecting a leakage current through the insulation layer to the heating conductor. A small conductor cross section may be advantageous for temperature measurement directly by means of the electrode.

The insulation layer can advantageously have an electrical resistance between a top side and a bottom side or between the heating conductor and the electrode that is at least 1 MΩ in a temperature range of from 100° C. to 150° C. Advantageously, this may even be at least 10 MΩ. At a specific temperature that is considered to be initially critical for the heating device in respect of a local increase in temperature, the electrical resistance can drop sharply. The material composition can be accordingly selected for this purpose. However, this is known in principle from the abovementioned prior art.

In a refinement of the invention, provision can be made for the entire electrical resistance of the electrode, that is to say between two electrode connections, to lie between 50Ω and 100 kΩ in said temperature range of between 0° C. and 500° C. In particular, the electrical resistance of the electrode can lie between 5 kΩ and 20 kΩ in this temperature range. The change in this electrical resistance with respect to the temperature or with a change in temperature has been described above.

For precise and reliable evaluation of the temperature, provision can be made for the electrode to have a constant width along its longitudinal extent. Specific regions can be evaluated more precisely by varying the profile of the electrode track, in particular by bends and/or straight sections. A thickness of the electrode should also be constant, in particular also for an improved ability to produce the electrode. A width can lie, for example, in the range of from 0.05 mm to 2 mm, and a thickness can lie between 3 μm and 1 mm. Furthermore, designs of a series circuit of different electrode track geometries are possible. One embodiment may be, for example, a series circuit comprising an electrode network and a sensor electrode. This has the advantage that the position of the hotspot can be determined by evaluating the two evaluation options leakage current and resistance measurement.

Provision is preferably made for a width of a heating conductor to be considerably greater than its length and also, in absolute terms, than the electrode. In particular, a heating conductor can be five times to one hundred times wider than an electrode, in particular than the electrode overlapped by the heating conductor. An abovementioned combination of an electrode network and a sensor electrode is also advantageously possible here.

In a yet further refinement of the invention, provision can be made for the electrode material to have a variable temperature coefficient of electrical resistance, advantageously to be a PTC material. As a result, it is possible, in the event of very high temperatures, that no excessive currents are able to flow through the electrode during measurement of the temperature.

In an advantageous refinement of the invention, provision can be made for the heating device to have a plurality of heating conductors or for a heating conductor to have a plurality of partial heating conductors. These can be interconnected with one another, for example and advantageously in a series circuit. A parallel circuit and a combination of a series circuit and a parallel circuit are possible in principle. Each of the partial heating conductors preferably covers an electrode or an electrode section, in particular with the abovementioned advantageous prespecification that a degree of coverage is at least 80% or 90%, in particular 100%. The individual partial heating conductors can be connected to one another by means of connecting sections, in particular in order to be able to avoid bends or curves in the partial heating conductor itself. These would be disadvantageous in respect of current guidance for known reasons. Although an electrode or an electrode section can be provided in the region of these connecting sections, this does not necessarily have to be the case. However, the profile of the electrode advantageously follows the profile of the heating conductor. The electrical resistance of said connecting sections should be considerably lower than that of the heating conductor material, advantageously lower at least by a factor of 10.

In a development of the invention, provision can be made for at least one additional electrode that consists of the same material as the electrode to be provided. This additional electrode also serves for temperature measurement, but it is not covered or overlapped by a heating conductor. A lateral distance between this additional electrode and a heating conductor or each heating conductor situated in the surrounding area, which distance is twice the width of the electrode track or at least 1 mm or even at least 2 mm, advantageously at least 10 mm, is preferably provided. Therefore, it is possible for the temperature at the additional electrode to be mainly or even exclusively influenced by the carrier or by a medium which the carrier adjoins or which the carrier contains, for example water. Temperature measurement at the additional electrode advantageously takes place by way of a change in its electrical resistance with respect to the temperature, that is to say just like in case of the electrode, as has been described above. Therefore, the additional electrode is also connected to the same temperature measuring device as the electrode that is covered or overlapped by the heating conductor.

The following layer structure can advantageously be provided for the heating device. A covering layer or a carrier insulation layer can be applied to the carrier, which can consist of ceramic or preferably of metal or steel. The at least one electrode, preferably all of the electrodes or electrode sections, in particular including an abovementioned additional electrode, is/are applied to this carrier insulation layer. The insulation layer according to the invention, through which a leakage current can flow in the event of a local excessively high temperature, is in turn applied to said electrode, electrodes or electrode sections. The heating conductor or all of the heating conductors and partial heating conductors is/are in turn applied to this insulation layer. A covering layer is in turn applied to the outside of said heating conductor, heating conductors or partial heating conductors, in particular in order to protect the heating conductor against the effects of the atmosphere or oxygen, that is to say primarily against oxidation. Electrical contact is made with the electrode and the heating conductor in a known way, in particular by way of said electrode and heating conductor not being covered by the respective insulation layers in the lateral direction.

As an alternative, the order can also be carrier, carrier insulation layer or dielectric layer, heating conductor, insulation layer or dielectric layer, electrode/s, covering layer.

In a method according to the invention for temperature measurement at such a heating device, provision is made for this to take place in two different ways. Firstly, temperature detection takes place by means of a temperature-dependent leakage current flowing through the insulation layer between the heating device and the electrode. In the process, it is possible to establish, in particular, that there is an excessively high local temperature if such a leakage current is actually flowing to an appreciable extent. Secondly, temperature measurement takes place at the heating device by way of a change in temperature at the electrode alone being measured and being determined by way of the temperature-dependent electrical resistance of the electrode. For this purpose, a control arrangement of the heating device or for the heating device can be provided, in which control arrangement this evaluation takes place as a change in temperature over time.

In a first general method according to the invention for producing an above-described heating device, this heating device has a plurality of heating conductors. This plurality of heating conductors may also be a plurality of above-described partial heating conductors. All of the heating conductors and possibly also all of the partial heating conductors of the heating device are applied in the same method section or in the same method step and from the same heating conductor material. If this takes place in a plurality of steps, this is also carried out in an identical manner for all of the heating conductors or partial heating conductors.

In a second method according to the invention for producing a heating device, as has been described above, the heating device has a plurality of electrodes. In particular, an above-described additional electrode is also provided. All of the electrodes or electrode sections, in particular including the abovementioned additional electrode, are applied in the same method step and from the same electrode material. Similarly to the manner described above for the heating conductor, it is also the case here that, in the event of a plurality of layers of the electrode material being applied, this takes place in an identical manner for all of the electrodes or electrode sections and also for an additional electrode that may be provided.

These and further features can be gathered not only from the claims but also from the description and the drawings, where the individual features can be realized in each case by themselves or severally in the form of subcombinations in an embodiment of the invention and in other fields and can constitute advantageous and inherently protectable embodiments for which protection is claimed here. The subdivision of the application into subheadings and individual sections does not restrict the general validity of the statements made thereunder.

### BRIEF DESCRIPTION OF THE DRAWINGS

Exemplary embodiments of the invention are schematically illustrated in the drawings and will be explained in greater detail below

FIG. 1 shows a plan view of a first refinement of a heating device according to the invention comprising a sheet-like heating conductor and a meandering electrode,

FIG. 2 shows a section through the heating device from FIG. 1 with the layer structure, and

FIG. 3 to FIG. 6 show various modifications of heating devices similar to FIG. 1 with different refinements for the heating conductor and the electrode.

### DETAILED DESCRIPTION OF THE EXEMPLARY EMBODIMENTS

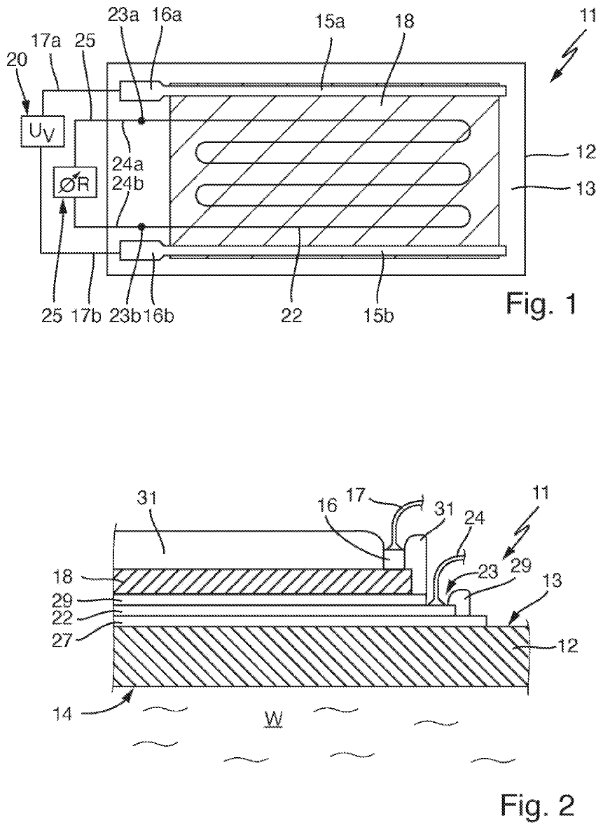

FIG. 1 shows a plan view of a heating device 11 according to the invention. Here, said heating device has a rectangular shape, but can also have any desired shape. In addition to planar refinements of a heating device 11, curved and tubular heating devices are also conceivable. In particular, the heating device 11 is produced using thick-film technology.

The heating device 11 has a carrier 12 which consists either of electrically insulating ceramic or of metal. Said layer structure is located on a carrier top side 13 which, in the case of a carrier 12 composed of metal, is provided with a functional insulation 27. Two contact tracks 15a and 15b composed of very highly electrically conductive material and situated parallel at a distance from one another are arranged on the carrier top side 13. Said contact tracks merge with contact areas 16a and 16b on the left. The contact tracks 15a and 15b make contact with a wide heating conductor 18 of sheet-like design between them. In this respect, reference is made, for example, to EP 3250003 A1. The current flow direction through the heating conductor 18 is at a right angle to the longitudinal extent of the contact tracks 15a and 15b here.

A supply voltage source 20 is connected to the contact areas 16a and 16b by means of contact lines 17a and 17b. This is known per se from the prior art. The supply voltage source is advantageously a domestic AC mains voltage of 230 V. Use in the automotive sector or in an automobile, that is to say a DC voltage of 12 V or 48 V or even more, is also possible.

An electrode 22 runs in a meandering manner in six parallel tracks in the area of the heating conductor 18. The tracks can each be at approximately the same distance from one another, but they can also be at different distances from one another, for example for different power densities or in order to be able to evaluate defined regions more precisely. The topmost track and the bottommost track can also run even closer to the contact tracks 15a and 15b. The electrode 22 has, on the left, two electrode connections 23a and 23b. A resistance measuring device 25 is connected by means of electrode lines 24a and 24b. Therefore, the electrical resistance of the electrode 22 can be measured, and the temperature can be determined on account of the temperature dependence of said electrical resistance. For this purpose, the electrode 22 consists of a material mentioned at the outset with a silver content of 10% to 90% or 80% to 90%. However, a material mentioned at the outset can also be used for the electrode.

It can be seen that the temperature measurement, on account of the temperature-dependent variable electrical resistance of the electrode 22, does not allow local temperature measurement at a single point, but rather temperature measurement as it were distributed or averaged over the area covered by the electrode 22. Leakage current detection, as is known from the prior art mentioned at the outset, is used for local temperature measurement, in particular for detecting dangerous local overtemperatures. The leakage current detection means is then connected by means of the contact lines 17a and 17b and electrode lines 24a and 24b.

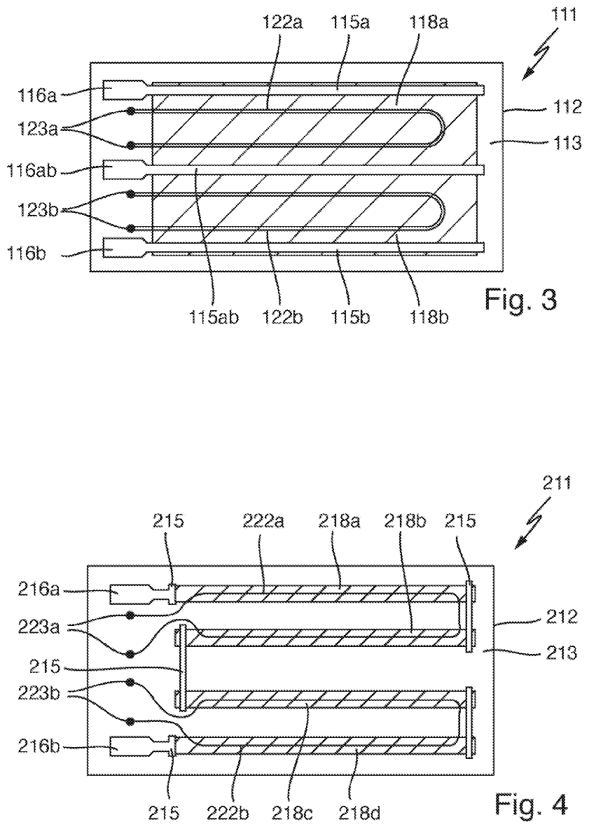

For explanatory purposes, reference is explicitly made to FIG. 2 and primarily to the abovementioned prior art. According to FIG. 2, the carrier 12 has a carrier top side 13 with the layer structure and has a carrier bottom side 14. Here, the carrier bottom side 14 is in contact with water W which is intended to be heated by the heating device 11. The layer structure, produced by means of thick-film technology, on the carrier top side 13 has, as the lowermost layer, said functional insulation 27 of the carrier 12. The electrode 22 is applied to the functional insulation 27 in the desired form. Variations of this form have been explained at the outset and will be described further below with reference to FIGS. 4 to 5. The electrode 22 has, on the right, an electrode connection 23 to which an electrode line 24 is connected, here for example welded. Said electrode line can also be soldered; as an alternative, contact-connection by means of pressed-on contacts or by means of a clamping plug is possible.

The electrode 22 is covered by an insulation layer 29 which has the dielectric properties mentioned at the outset. These include that, at a specific relatively high temperature, for example 350° C. to 400° C., the electrical resistance drops sharply and a leakage current can flow. Here, this leakage current can flow from the heating conductor 18 applied to the insulation layer 29 to the electrode 22. The heating conductor 18 in turn has, on the right, a contact area 16 applied to it, which contact area can be connected by means of a contact line 17. At this temperature, there is a risk of permanent damage if it prevails over a time period of more than 1 minute or more than 20 seconds.

A covering layer 31 is in turn applied to the heating conductor 18. Said covering layer leaves out the contact area 16 for subsequent attachment of the contact line 17, similarly to the way in which, when applying the insulation layer 29, the electrode connection 23 remains free. The covering layer 31 serves to protect the structure of the carrier device 11 to the outside, in particular to protect the heating conductor 18 against the surrounding atmosphere and in particular against oxidation.

At this point, the functional principle of the leakage current measurement and temperatures at which it can be carried out are not discussed further here since this can be sufficiently gathered from the prior art. With reference to FIG. 1, this means that the leakage current flows from the heating conductor 18 to the electrode 22 at a particular hotspot of the insulation layer 29 between the two. No leakage current or no appreciable leakage current flows in the range considerably below said critical temperature.

Measurement of the temperature of the heating device 11 by way of the temperature-dependent electrical resistance of the electrode 22 can take place at any time. This can advantageously also take place at the same time as the leakage current monitoring.

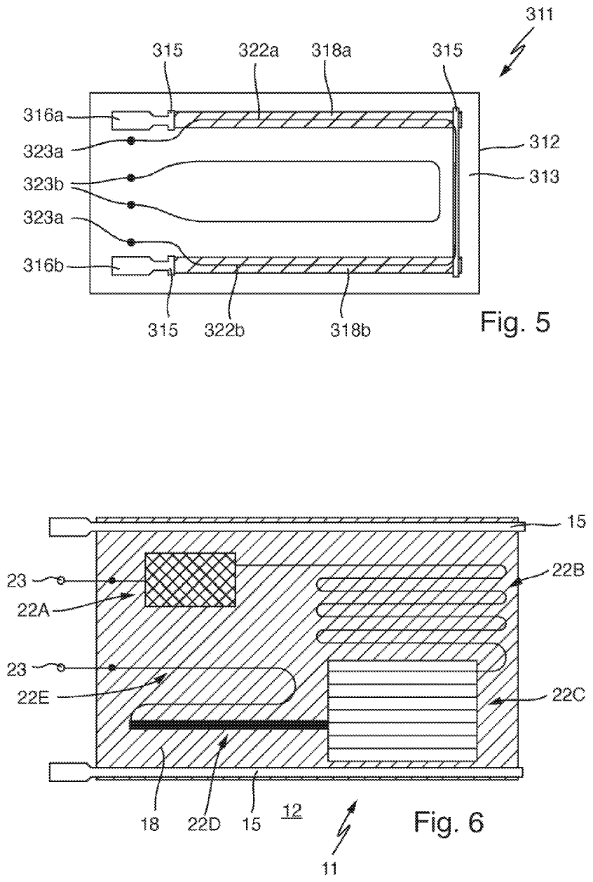

FIG. 3 shows an alternative structure. The heating device 111 with a carrier 112 has three parallel contact tracks 115a, 115ab and 115b on the carrier top side. Said contact tracks have, on the left, respective contact areas 116a, 116ab and 116b. This is still similar to the case as in FIG. 1. A continuous area can be covered by the heating conductor 118, that is to say from the upper contact track 115a down to the lower contact track 115b. The middle contact track 115ab runs in the middle and forms a kind of intermediate tap. Depending on the application of a supply voltage to the contact areas 116a, 116ab and 116b, the two heating conductors 118a and 118b can be connected in series or in parallel with one another, possibly also at different supply voltages, as partial heating conductors.

An upper electrode 122a runs in a single loop above the upper partial heating conductor 118a between the contact track 115a and the contact track 115ab. Said upper electrode can be electrically contacted, on the left, via two electrode connections 123a and can be connected, for example in accordance with FIG. 1, to a resistance measuring device, not illustrated here. Similarly, a leakage current detection means can be connected in the abovementioned way. A lower electrode 122b of identical design runs above the lower partial heating conductor 118b between the contact track 115ab and the contact track 115b. Said lower electrode can be electrically contacted via electrode connections 123b, provided on the left, in said way. Therefore, not only is leakage current detection possible via the two partial heating conductors 118a and 118b, but also respective detection of the absolute temperature.

A further alternative structure of a heating device 211 according to the invention is shown in FIG. 4. Four parallel strip-like partial heating conductors 218a, 218b, 218c and 218d are provided here. They are connected to one another in series by means of contact tracks 215 and have two contact areas 216a and 216b. In turn, two electrodes, specifically an upper electrode 222a and a lower electrode 222b, are provided. The upper electrode 222a runs, as it were, in a loop virtually entirely centrally along the two partial heating conductors 218a and 218b. Said upper electrode can be electrically contacted via electrode connections 223a at its ends. In a similar way, the lower electrode 222b runs along virtually the entire length of the two lower partial heating conductors 218c and 218d. Said lower electrode is electrically contacted by means of electrode connections 223b at its ends. Therefore, here, leakage current detection is possible in two regions since there are just two electrodes 222a and 222b separated from one another. Similarly, even though the four partial heating conductors are always operated in the same way in series, temperature measurement can take place by way of the temperature-dependent electrical resistance of the electrodes 222a and 222b both in the upper half and in the lower half separately.

A yet further alternative structure of a heating device 311 is shown in FIG. 5. Two spaced-apart and parallel partial heating conductors 318a and 318b are provided on a carrier 312 with a carrier top side 313, in a seemingly simplified manner in relation to FIG. 4. Said partial heating conductors are connected, on the right, by means of a contact track 315. At the left-hand side ends, said partial heating conductors can be electrically connected in the abovementioned manner by means of a short contact track 315 and contact areas 316a and 316b. The distance between said partial heating conductors is relatively large, but can also be smaller, in particular even only twice to four times the width of a single partial heating conductor.

Similarly to the situation in FIG. 4, an outer electrode 322a runs over virtually the entire length both of the upper partial heating conductor 318a and of the lower partial heating conductor 318b. In so doing, it also runs below the right-hand-side contact track 315 where, however, a leakage current is not expected. Nevertheless, temperature measurement can also take place here. This outer electrode 322a can be electrically contacted by means of contact areas 323a.

An inner electrode 322b with two electrode connections 323b runs in a loop within the free area between the two partial heating conductors 318a and 318b. Said inner electrode can also be used for leakage current measurement, where it can hardly be assumed that a leakage current occurs on the inner electrode 322b given this large distance from the partial heating conductors 318a and 318b. For this purpose, the outer electrode 322a is finally provided. The inner electrode 323b can be provided exclusively for temperature measurement. Said inner electrode can advantageously be applied in the same production step as the outer electrode 322a, so that a temperature measuring device or a kind of temperature sensor can thus be created in the same step in which the outer electrode 322a required for leakage current detection is also applied. All of the layers, as can be seen in FIG. 2, are advantageously applied by thick-film processes, in particular by means of screen printing. Therefore, the complexity of the method is very low, and costs are incurred substantially only due to the additional electrode material. Furthermore, owing to this inner electrode 322b, temperature measurement somewhat at a distance from the partial heating conductors 318a and 318b is possible, this being regarded as advantageous. Therefore, corruption of a temperature, for example a temperature of the water heated by the heating device 311 similarly to FIG. 2, due to the inherent relatively high temperature of the heating conductor is reduced per se or even prevented.

FIG. 6 shows, in a simplified manner, a heating device 11 with a carrier 12, in which heating device a heating conductor 18 of large surface area runs between two contact tracks 15, similarly to FIG. 1. Various possible designs of electrodes 22A to 22E are applied in the area between the contact tracks 15. Said electrodes are each illustrated only in a manner reduced in size and by way of example for basic illustration. Said electrodes have two electrode connections 23. There could also be at least two electrode connections in the sense that an additional center tap would possibly still be present.

The electrode 22A is of sheet-like design. Even though said electrode is shown with only a small surface area here, in particular covers a smaller area than the area of the heating conductor 18 between the two contact tracks 15, it can have a considerably larger surface area in practice. In particular, said electrode can take up virtually the entire area of the heating conductor 18 between the two contact tracks 15. Therefore, the electrode 22A is an example of a sheet-like design or design of large surface area.

The electrode 22B is designed in a similar manner to in FIG. 1. Said electrode is relatively narrow and meandering and long. The electrode 22C is of sheet-like design similarly to the electrode 22A and somewhat larger.

The electrode 22D is of elongate design but considerably wider than the electrode 22B and also the narrow electrode 22E above it. Said electrode is intended to illustrate that an elongate electrode that is designed as an electrode track can also have a certain width. The width can be provided so that the electrode covers a certain area or so that it has a certain quantity of resistance material, that is to say it has a certain electrical resistance, given a defined or prespecified thickness. Therefore, the width of the electrode can be used as a parameter for achieving a specific electrical resistance given a prespecified resistance material.

1. A heating device comprising a temperature measuring device for said heating device, where said heating device has:
a sheet-like carrier,
at least one heating conductor on said sheet-like carrier,
an elongate electrode on said sheet-like carrier,
a layer structure on said carrier with an insulation layer between said heating conductor and said electrode,
a measuring apparatus for detecting local high temperatures at said heating device, where said measuring apparatus is connected to said electrode and to said heating conductor and is designed to detect a temperature-dependent leakage current through said insulation layer between said heating conductor and said electrode and to evaluate said temperature-dependent leakage current as a measure of a local change in temperature at said heating device,
wherein:
said electrode consists of an electrode material having an electrical resistance and having a temperature dependence of said electrical resistance, where said temperature dependence lies between 0.0005/° C. and 0.01/° C. or between 500 ppm/K and 10,000 ppm/K in a temperature range of between 0° C. and 500° C.,
said temperature measuring device is connected to said electrode for a purpose of measuring a temperature at said electrode using said temperature dependence of said electrical resistance of said electrode.

2. The heating device as claimed in claim 1, wherein said temperature dependence of said electrical resistance of said electrode material lies between 0.0015/° C. and 0.005/° C. or between 1,500 ppm/K and 5,000 ppm/K in said temperature range of between 0° C. and 500° C.

3. The heating device as claimed in claim 1, wherein said electrode is at least partially covered by said heating conductor, with said insulation layer therebetween.

4. The heating device as claimed in claim 3, wherein a section of said electrode, covered by said heating conductor, runs along a direction of a longitudinal extent of said heating conductor.

5. The heating device as claimed in claim 4, wherein a section of said electrode, covered by said heating conductor, runs along at least 70% or 90% of a length of said longitudinal extent of the heating conductor.

6. The heating device as claimed in claim 1, wherein said electrode has a width being relatively small in comparison to a length of said electrode, where said length of said electrode is at least 20 times of said width.

7. The heating device as claimed in claim 1, wherein said insulation layer has an electrical resistance between a top side and a bottom side or between said heating conductor and said electrode of at least 1 MΩ in a temperature range of between 0° C. and 150° C.

8. The heating device as claimed in claim 1, wherein said electrode has a total electrical resistance of between 50Ω and 100 kΩ in said temperature range of between 0° C. and 500° C.

9. The heating device as claimed in claim 1, wherein said electrode has a longitudinal extent and has a constant width along said longitudinal extent.

10. The heating device as claimed in claim 1, wherein said electrode has a longitudinal extent and has a constant thickness along said longitudinal extent.

11. The heating device as claimed in claim 1, wherein said electrode has a content of silver of up to at most 95% as said electrode material.

12. The heating device as claimed in claim 1, wherein said electrode material has a variable temperature coefficient of said electrical resistance.

13. The heating device as claimed in claim 1, wherein said heating conductor has a plurality of partial heating conductors, wherein said partial heating conductors are interconnected with one another, wherein each of said partial heating conductors covers one said electrode or an electrode section.

14. The heating device as claimed in claim 13, wherein connecting sections are provided between said individual partial heating conductors, wherein said connecting sections are composed of a conductor material, said conductor material having a specific electrical resistance, said specific electrical resistance being lower at least by a factor of 10 than in said heating conductor.

15. The heating device as claimed in claim 1, wherein at least one additional electrode composed of the same material as said electrode is provided, said additional electrode not being covered or overlapped by one said heating conductor, where a lateral distance between said additional electrode and one said heating conductor is at least 1 mm or at least 2 mm or is twice a width of said electrode.

16. The heating device as claimed in claim 15, wherein said additional electrode is also connected to said temperature measuring device.

17. The heating device as claimed in claim 1, wherein a carrier insulation layer is applied to said carrier, said at least one electrode is applied to said carrier insulation layer, said insulation layer is applied to this electrode, said heating conductor is applied to said insulation layer, and a covering layer is applied to said heating conductor.

18. The heating device as claimed in claim 1, wherein a carrier insulation layer is applied to said carrier, said heating conductor is applied to said carrier insulation layer, an insulation layer or a dielectric layer is applied to said heating conductor, an electrode is applied to said insulation layer or to said dielectric layer, and a covering layer is applied to said electrode.

19. A method for temperature measurement at a heating device as claimed in claim 1, wherein in a first step a temperature detection takes place by means of a temperature-dependent leakage current flowing through said insulation layer between said heating device and said electrode, and wherein in a second step temperature measurement takes place at said heating device by way of a change in temperature at said electrode alone being measured.

20. The method as claimed in claim 19, wherein a change in temperature at said electrode is evaluated as a change in temperature over time.

21. A method for producing a heating device as claimed in claim 1, wherein said heating device has a plurality of said heating conductors, where all of said heating conductors and possibly also partial heating conductors of said heating device are applied in the same method step and from the same heating conductor material.

22. The method as claimed in claim 21, wherein said heating conductor has a plurality of partial heating conductors which are interconnected with one another, where each of said partial heating conductors covers an electrode or an electrode section, where all of said heating conductors and possibly also said partial heating conductors of said heating device are applied in said same method step and from said same heating conductor material.

23. A method for producing a heating device as claimed in claim 1, wherein said heating device has a plurality of said electrodes, where all of said electrodes of said heating device are applied in the same method step and from the same electrode material.

24. The method as claimed in claim 23, wherein said heating device has at least one additional electrode composed of said same material as said electrode and not being covered or overlapped by a heating conductor, wherein a lateral distance between said additional electrode and one said heating conductor is at least 1 mm or at least 2 mm or is twice a width of said electrode.
